(19) United States
(12) Patent Application Publication
(10) Pub. No.: US 2019/0098373 A1
(43) Pub. Date: Mar. 28, 2019

(54) PACKET OUTPUTTING DEVICE AND PACKET OUTPUTTING METHOD

(71) Applicant: MStar Semiconductor, Inc., Hsinchu Hsien (TW)

(72) Inventors: Szu-Hsiang LAI, Hsinchu Hsien (TW); Kai-Wen CHENG, Hsinchu Hsien (TW); Yi-Ying LIAO, Hsinchu Hsien (TW)

(21) Appl. No.: 16/040,670

(22) Filed: Jul. 20, 2018

(30) Foreign Application Priority Data
Sep. 25, 2017 (TW) 106132796

(51) Int. Cl. H04N 21/8547; H04N 21/2365; H04N 21/61; H04B 7/185; H04L 1/00; H04L 5/00; H04L 29/06

(52) U.S. Cl. CPC H04N 21/8547; H04N 21/23655; H04N 21/6143; H04L 65/4069; H04L 1/0003; H04L 5/0042; H04L 5/0044; H04B 7/18523

(57) ABSTRACT

A packet output device includes: a first extracting unit, extracting a plurality of first packets and a plurality of first null packet values corresponding to a first channel; a first buffer, storing the first packets and the first null packet values; a second extracting unit, extracting a plurality of second packets and a plurality of second null packet values corresponding to a second channel; a second buffer, storing the second packets and the second null packet values; and a packet outputting unit, selecting, according to the first null packet values and the second null packet values, one of the first packets and the second packets as an output packet.

This application claims the benefit of Taiwan application Serial No. 106132796, filed on Sep. 25, 2017, the subject matter of which is incorporated herein by reference.

### BACKGROUND OF THE INVENTION

### Field of the Invention

The invention relates to a packet output device and a packet output method, and more particularly to a packet output device and a packet output method applicable to the Digital Video Broadcasting—Satellite Second Generation Extension (DVB-S2X) standard.

### Description of the Related Art

In the Digital Video Broadcasting—Satellite Second Generation Extension (DVB-S2X) standard, a transmitting end can split a transport stream of a program into multiple transport streams, which are then transmitted by using multiple channels.

FIG. 1 shows a schematic diagram of splitting a transport stream TS. As shown in FIG. 1, the transport stream TS may include packets P0 to P10. The packet P0 corresponds to time 0 to 100, the packet P1 corresponds to time 100 to 200, and so forth. A transmitting end may first split the transport stream TS into a transport stream TS0 and a transport stream TS1, which respectively correspond to channels ch0 and ch1. The transport stream TS0 includes packets P0 to P2, P5, P9 and P10, the transport stream TS1 includes packets P3, P4, and P6 to P8. Because the packets P3 and P4 are not included in the transport stream TS0, positions corresponding to the packets P3 and P4 in the transport stream TS0 are inserted with two null packets N. Similarly, because the packets P0 to P2 are not included in the transport stream TS1, positions corresponding to the packets P0 to P2 in the transport stream TS1 are inserted with three null packets N, and so forth.

Next, the transmitting end may delete the null packets from the transport streams TS0 and TS1, and insert multiple deleted null packet (DNP) fields, in which multiple null packet values indicate the number of null packets deleted, to generate user packet streams UPS0 and UPS1. For example, in the transport stream TS0, there are no deleted null packets before the packets P0, P1 and P2, and so null packet values DNP0, DNP1 and DNP2 respectively corresponding to the packets P0, P1 and P2 are all 0; whereas, there are two deleted null packets before the packet P5, and so the null packet value DNP5 corresponding to the packet P5 is 2. Similarly, in the transport stream TS1, there are three deleted null packets before the packet P3, and so the null packet value DNP3 corresponding to the packet P3 is 3, and so forth.

The transmitting end may eventually add a baseband header (BBHD) into the user packets UPS0 and UPS1 to form baseband frame streams BFS_0 and BFS_1. The baseband frame stream BFS_0 includes baseband frames BF_0_1, BF_0_2, BF_0_3, . . . , and is transmitted through the channel ch0; the baseband frame stream BFS_1 includes baseband frames BF_1_1, BF_1_2, BF_1_3 . . . , and is transmitted through the channel ch1. A receiving end respectively receives the baseband frame streams BFS_0 and BFS_1 from the channels ch0 and ch1. Therefore, it is a goal of the related field as how to restore the original transport stream TS from the baseband frame streams BFS_0 and BFS_1.

### SUMMARY OF THE INVENTION

Therefore, it is an object of the present invention to provide a packet output device and a packet output method so as to restore an original transport stream from multiple baseband frame streams received from multiple channels.

The present invention discloses a packet output device, including: a first extracting unit, extracting a plurality of first packets and a plurality of first null packet values corresponding to a first channel, wherein the first null packet values respectively correspond to the first packets; a first buffer, storing the first packets and the first null packet values; a second extracting unit, extracting a plurality of second packets and a plurality of second null packet values, wherein the second packets respectively correspond to the second null packet values; a second buffer, storing the second packets and the second null packet values; and a packet outputting unit, selecting, according to the first null packet values and the second null packet values, one of the first packets and the second packets as an output packet.

The present invention further discloses a packet output method, including: extracting a plurality of first packets and a plurality of first null packet values corresponding to a first channel, wherein the first null packet values respectively correspond to the first packets; storing the first packets and the first null packet values in a first buffer; extracting a plurality of second packets and a plurality of second null packet values corresponding to a second channel, wherein the second packets respectively correspond to the second null packet values; storing the second packets and the second null packet values in a second buffer; and selecting, according to the first null packet values and the second null packet values, one of the first packets and the second packets as an output packet.

The above and other aspects of the invention will become better understood with regard to the following detailed description of the embodiments. The following description is made with reference to the accompanying drawings.

### BRIEF DESCRIPTION OF THE DRAWINGS

FIG. 1 is a schematic diagram of splitting a transport stream;

FIG. 2 is a block diagram of a packet output device according to an embodiment of the present invention;

FIG. 3 is a flowchart of a packet output method according to an embodiment of the present invention;

FIG. 4A to FIG. 4G are schematic diagrams of queues stored in buffers according to an embodiment of the present invention;

FIG. 5 is a detailed flowchart of a packet output method according to an embodiment of the present invention; and

FIG. 6 is a block diagram of a packet output device according to an embodiment of the present invention

### DETAILED DESCRIPTION OF THE INVENTION

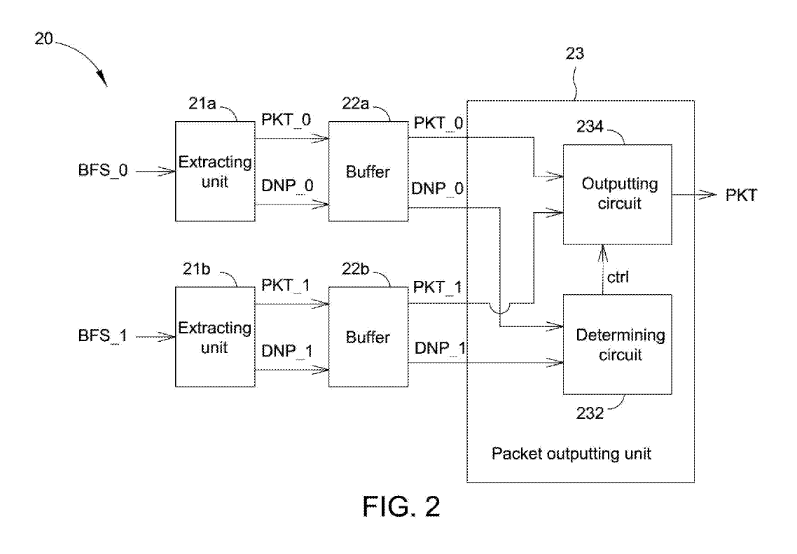

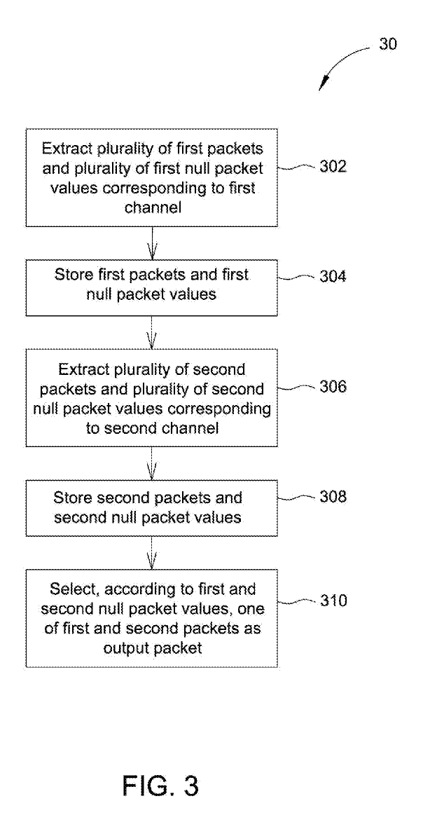

FIG. 2 shows a block diagram of a packet output device 20 according to an embodiment of the present invention. The packet output device 20 is capable of restoring a transport stream based on baseband frame streams BFS_0 and BFS_1 carried in channels ch0 and ch1. The packet output device 20 includes a plurality of extracting units 21a and 21b, a plurality of buffers 22a and 22b, and a packet outputting unit 23. FIG. 3 shows a flowchart of a packet output method 30 according to an embodiment of the present invention.

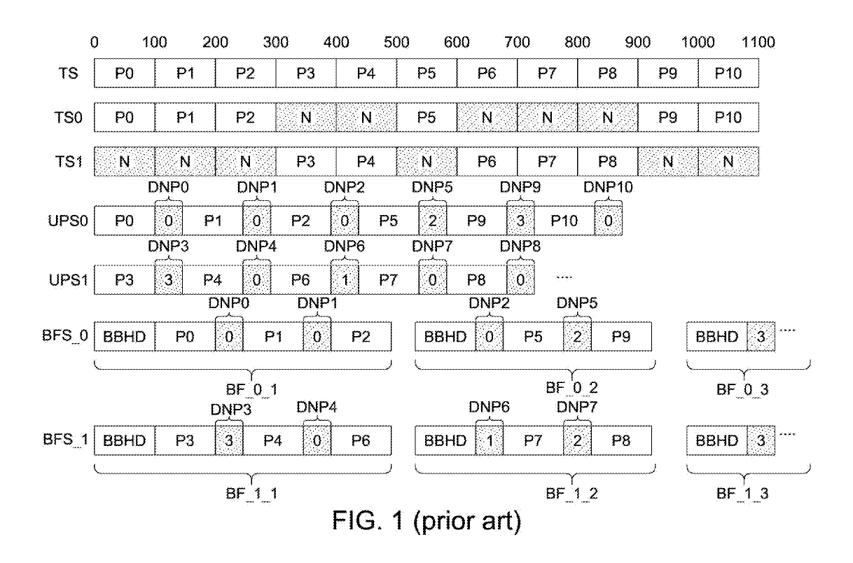

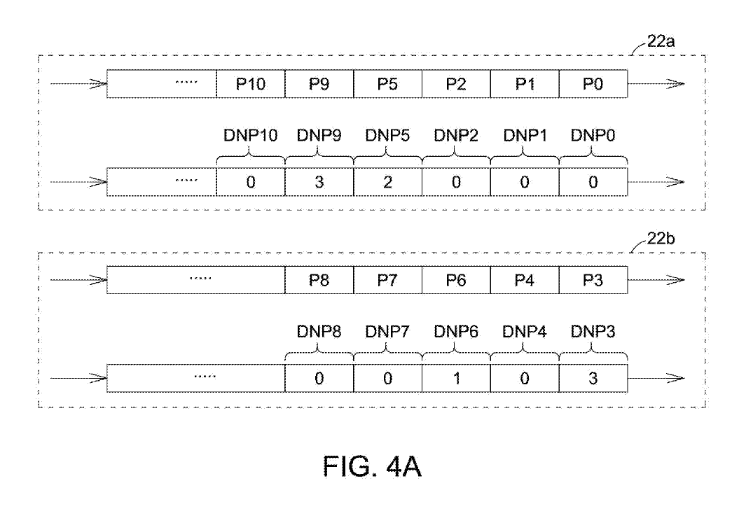

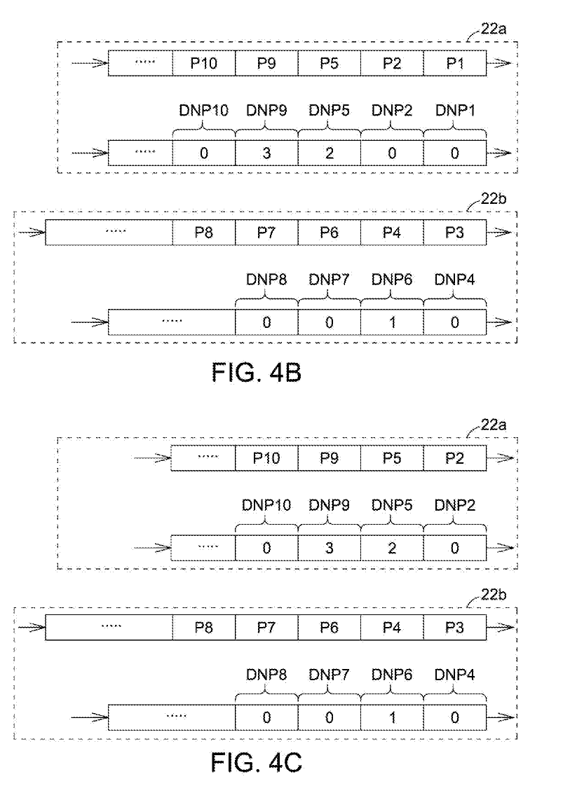

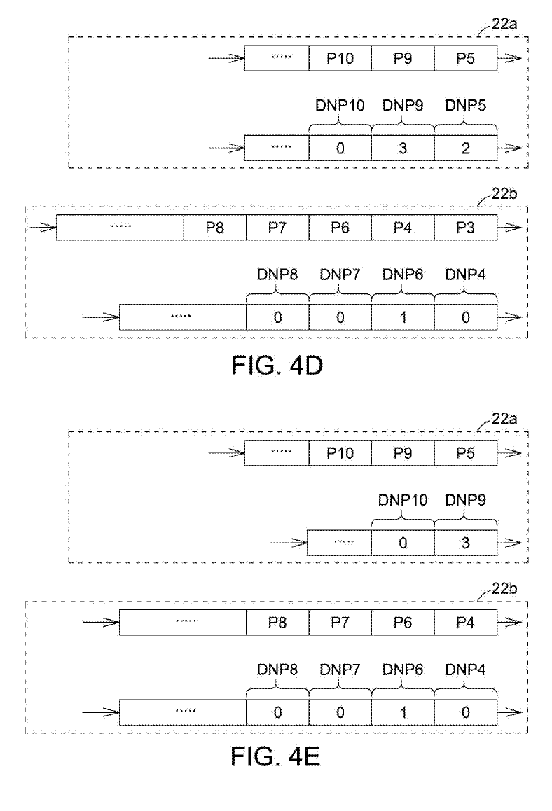

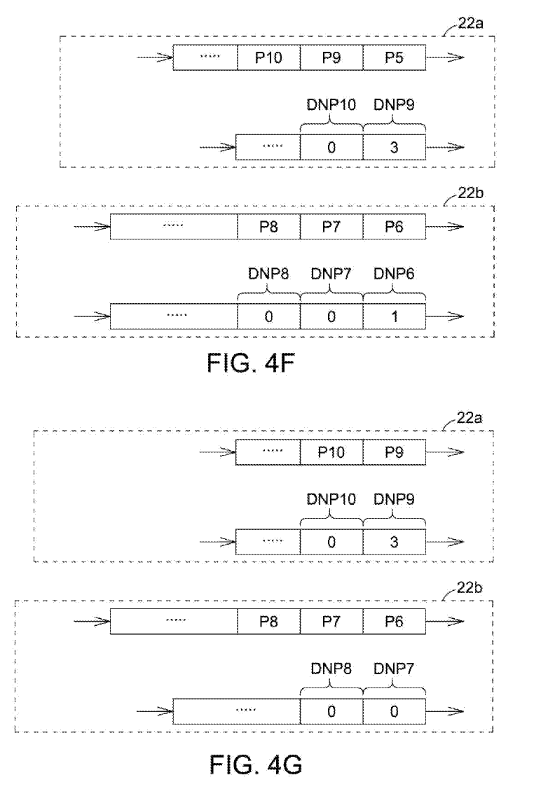

Referring to FIG. 2 and FIG. 3, the extracting unit 21 extracts, from the baseband frame stream BFS_0 received from the channel ch0, a plurality of packets PKT_0 and a plurality of null packet values DNP_0 corresponding to the channel ch0 (step 302), wherein the null packet values DNP_0 respectively correspond to the packets PKT_0. Taking the baseband frame stream BFS_0 in FIG. 1 for example, the packets PKT_0 include packets P0, P1, P2, P5, P9 and P10, the null packet values DNP_0 include null packet values DNP0, DNP1, DNP2, DNP5, DNP9 and DNP10. The extracting unit 21a then outputs the packets PKT_0 and the null packet values DNP_0 to the buffer 22a, which stores the packets PKT_0 and the null packet values DNP_0 (step 304). In one embodiment, the packets PKT_0 and the null packet values DNP_0 are stored in the buffer 22a by means of first-in-first-out (FIFO) according to time points at which they are extracted. In other words, the packets PKT_0 and the null packet values DNP_0 corresponding to the channel ch0 form FIFO queues in the buffer 22a, as shown in FIG. 4A.

Similarly, the extracting unit 21b extracts, from the baseband frame stream BFS_1 received from the channel ch1, a plurality of packets PKT_1 and a plurality of null packet values DNP_1 corresponding to the channel ch1 (step 306), wherein the null packet values DNP_1 respectively correspond to the packets PKT_1. Taking the baseband frame stream BFS_1 in FIG. 1 for example, the packets PKT_1 include the packets P3, P4, P7, P8 and P10, the null packet values DNP_1 include the null packet values DNP3, DNP4, DNP7, DNP8 and DNP10. The extracting unit 21b then outputs the packets PKT_1 and the null packet values DNP_1 to the buffer 22b, which stores the packets PKT_1 and the null packet values DNP_1 (step 308). In one embodiment, the packets PKT_1 and the null packet values DNP_1 are stored in the buffer 22b by means of first-in-first-out (FIFO) according to time points at which they are extracted. In other words, the packets PKT_1 and the null packet values DNP_1 corresponding to the channel ch1 form FIFO queues in the buffer 22b, as shown in FIG. 4A.

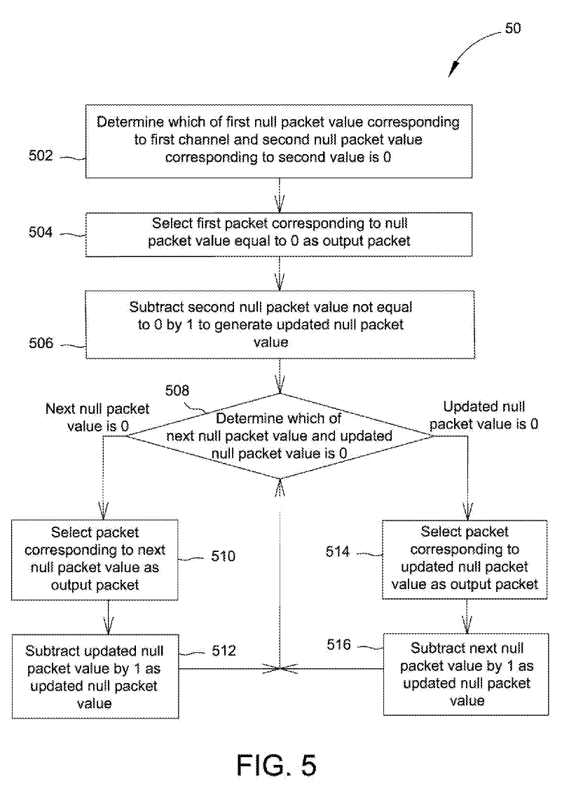

The packet outputting unit 23 is coupled to the buffers 22a and 22b, and selects, according to the null packet values DNP_0 and DNP_1 stored in the buffers 22a and 22b, one of these packets PKT_0 and PKT_1 as an output packet PKT (step 310). In one embodiment, the packet outputting unit 23 includes a determining circuit 232 and an outputting circuit 234. FIG. 5 shows a detailed flowchart of a packet output method 50 according to an embodiment of the present invention. The determining circuit 232 respectively reads one null packet value DNP_0 corresponding to the channel ch0 and one null packet value DNP_1 corresponding to the channel ch1 from the buffers 22a and 22b, and determines which of the null packets DNP_0 and DNP_1 is 0 (step 502) to generate a packet output signal ctrl to the outputting circuit 234. The outputting circuit 234 selects, according to the packet output signal ctrl, one of the packets PKT_0 and PKT1 corresponding to a null packet value of 0 as the output packet PKT (step 504). For example, the outputting circuit 234 may be a multiplexer (MUX). The determining circuit 232 reads null packet values stored at earliest time points in the buffers 22a and 22b, and the read null packet values are deleted from the buffers 22a and 22b once the determining circuit 232 finishes reading the null packet values.

Taking the buffers 22a and 22b in FIG. 4A for example, the determining circuit 232 respectively reads the null packet value DNP0 corresponding to the channel ch0 and the null packet value DNP3 corresponding to the channel ch1 from the buffers 22a and 22b. Because DNP0=0 and DNP3=3, the determining circuit 232 accordingly generates the packet output signal ctrl to control the outputting circuit 234 to select the packet P0 corresponding to the null packet value DNP0 having a value of 0 as the output packet PKT. Further, the packet P0 and the null packet value DNP0 are deleted from the buffer 22a, and the null packet value DNP3 is deleted from the buffer 22b, as shown in FIG. 4B. The determining circuit 232 further subtracts the null packet value DNP3 having a non-zero value by 1 to generate an updated null packet value DNP_U (step 506), and stores the updated null packet value DNP_U in a register. In continuation of the above example, because DNP3=3, the updated null packet value DNP_U=DNP3′=3−1=2.

The determining circuit 232 then determines which of a next null packet value DNP_N and the updated null packet value DNP_U is 0 (step 508) to generate the packet output signal, wherein the next null packet value DNP_N and the updated null packet value DNP_U respectively correspond to different channels. In continuation of the above example, because the updated null packet value DNP_U is DNP3′ which corresponds to the channel ch1, the next null packet value DNP_N is the null packet value DNP1 corresponding to the channel ch0. As DNP3′=2 and DNP1=0, the determining circuit 232 accordingly generates the packet output signal ctrl to control the outputting circuit 234 to select the packet P1 corresponding to the null packet value DNP1 equal to 0 as the output packet PKT (step 510). Further, the packet P1 and the null packet value DNP1 are deleted from the buffer 22a, as shown in FIG. 4C. The determining circuit 232 further subtracts the null packet value DNP3′ having a non-zero value by 1 as the updated null packet value DNP_U (step 512), and stores the updated null packet value DNP_U in the register. In continuation of the above example, because DNP3′=2, the updated null packet value DNP_U=DNP3″=2−1=1.

Because the updated null packet value DNP_U is DNP3″ which corresponds to the channel ch1, the next null packet value DNP_N is the null packet value DNP2 corresponding to the channel ch0. As DNP3″=1 and DNP2=0, the determining circuit 232 accordingly generates the packet output signal ctrl to control the outputting circuit 234 to select the packet P2 corresponding to the null packet value DNP2 equal to 0 as the output packet PKT (step 510). Further, the packet P2 and the null packet value DNP2 are deleted from the buffer 22a, as shown in FIG. 4D. The determining circuit 232 further subtracts the null packet value DNP3″ having a non-zero value by 1 as the updated null packet value DNP_U (step 512), and stores the updated null packet value DNP_U in the register. In continuation of the above example, because DNP3″=1,the updated null packet value DNP_U=DNP3′″=1−1=0.

Because the updated null packet value DNP_U is DNP3′″ which corresponds to the channel ch1, the next null packet value DNP_N is the null packet value DNP5 corresponding to the channel ch0. As DNP3′″=0 and DNP5=2, the determining circuit 232 accordingly generates the packet output signal ctrl to control the outputting circuit 234 to select the packet P3 corresponding to the null packet value DNP3 equal to 0 as the output packet PKT (step 514). Further, the null packet value DNP5 is deleted from the buffer 22a, and the packet P3 is deleted from the buffer 22b, as shown in FIG. 4E. The determining circuit 232 further subtracts the null packet value DNP5 having a non-zero value by 1 as the updated null packet value DNP_U (step 516), and stores the updated null packet value DNP_U in the register. In continuation of the above example, because DNP5=2, the updated null packet value DNP_U=DNP5′=2−1=1.

Next, because the updated null packet value DNP_U is DNP5′ which corresponds to the channel ch0, the next null packet value DNP_N is the null packet value DNP4 corresponding to the channel ch1. As DNP4=0 and DNP5′=1, the determining circuit 232 accordingly generates the packet output signal ctrl to control the outputting circuit 234 to select the packet P4 corresponding to the null packet value DNP4 equal to 0 as the output packet PKT (step 510). Further, the packet P4 and the null packet value DNP4 are deleted from the buffer 22b, as shown in FIG. 4F. The determining circuit 232 further subtracts the null packet value DNP5′ having a non-zero value by 1 as the updated null packet value DNP_U (step 512), and stores the updated null packet value DNP_U in the register. In continuation of the above example, because DNP5′=1, the updated null packet value DNP_U=DNP5″=1−1=0.

Next, because the updated null packet value DNP_U is DNP5″ which corresponds to the channel ch0, the next null packet value DNP_N is the null packet value DNP6 corresponding to the channel ch1. As DNP5″=0 and DNP6=1, the determining circuit 232 accordingly generates the packet output signal ctrl to control the outputting circuit 234 to select the packet P5 corresponding to the null packet value DNP5″ equal to 0 as the output packet PKT (step 514). Further, the packet P5 is deleted from the buffer 22a, and the null packet value DNP6 is deleted from the buffer 22b, as shown in FIG. 4G. The determining circuit 232 further subtracts the null packet value DNP6 having a non-zero value by 1 as the updated null packet value DNP_U (step 516), and stores the updated null packet value DNP_U in the register. In continuation of the above example, because DNP6=1, the updated null packet value DNP_U=DNP6′=1−1=0. The same process is similarly performed for other packets and null packet values. As such, the outputting circuit 23 may sequentially output the packets P0, P1, P2, P3, P4, P5, . . . to restore the transport stream TS shown in FIG. 1.

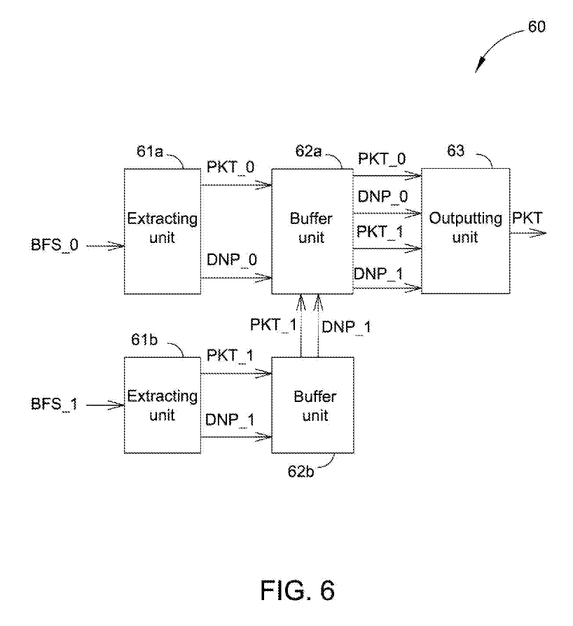

FIG. 6 shows a block diagram of a packet output device 60 according to another embodiment of the present invention. The packet output device 60 includes a plurality of extracting units 61a and 61b, a plurality of buffers 62a and 62b, and a packet outputting unit 63. Different from the packet output device 20 in FIG. 2, in the packet output device 60, the buffer 62b is coupled to the buffer 62a, and the buffer 62a is used to receive and store the packets PTK_1 and the null packet values DNP_1 transmitted from the buffer 62b. The packet outputting unit 63 of the packet output device 63 is coupled to only the buffer 62a but not to the buffer 62b. Thus, the packet outputting unit 63 receives the packets PKT_0 and PKT_1 as well as the null packet values DNP_0 and DNP_1 from the buffer 62a, and selects, according to the null packet values DNP_0 and DNP_1, one of the packets PKT_0 and PKT_1 as the output packet PKT. Compared to the packet output device 20 in FIG. 2, the packet outputting unit 63 of the packet output device 60 uses a smaller number of pins, and is capable of reducing the data bandwidth usage of the packet output device 60.

While the invention has been described by way of example and in terms of the embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A packet output device, comprising:
a first extracting unit, extracting a plurality of first packets and a plurality of first null packet values corresponding to a first channel, wherein the plurality of first packets respectively correspond to the plurality of first null packet values;
a first buffer, storing the plurality of first packets and the plurality of first null packet values;
a second extracting unit, extracting a plurality of second packets and a plurality of second null packet values corresponding to a second channel, wherein the plurality of second packets respectively correspond to the plurality of second null packet values;
a second buffer, storing the plurality of second packets and the plurality of second null packet values; and
a packet outputting unit, selecting, according to the plurality of first null packet values and the plurality of second null packet values, one of the plurality of first packets and the plurality of second packets as an output packet.

2. The packet output device according to claim 1, wherein the packet outputting unit comprises:
a determining circuit, determining which of a first null packet value corresponding the first channel and a second null packet value corresponding to the second channel is 0 to generate a packet output signal; and
an outputting circuit, selecting a first packet as the output packet according to the packet output signal, wherein the first null packet value corresponding to the first packet is 0.

3. The packet output device according to claim 2, wherein the determining circuit further subtracts the second null packet value by 1 to generate an updated null packet value, and the second null packet value corresponding to the second packet is not 0.

4. The packet output device according to claim 3, wherein the determining circuit further determines which of a next null packet and the updated null packet value is 0 to generate the packet output signal, and the next null packet value and the updated null packet value respectively correspond to different channels.

5. The packet output device according to claim 4, wherein the outputting unit further selects, according to the packet output signal, a packet corresponding to the next null packet value as the output packet; and the determining circuit further subtracts the updated null packet value by 1 as the updated null packet value.

6. The packet output device according to claim 4, wherein the outputting circuit further selects, according to the packet output signal, a packet corresponding to the updated null packet value as the output packet; and the determining circuit further subtracts the next null packet by 1 as the updated null packet value.

7. The packet output device according to claim 1, wherein the first buffer further stores the plurality of second packets and the plurality of second null packet values received from the second buffer, and the packet outputting unit receives the second packet and the second null packet value from the first buffer.

8. A packet output method, comprising:
extracting a plurality of first packets and a plurality of first null packet values corresponding to a first channel, wherein the plurality of first packets respectively correspond to the plurality of first null packet values;
storing the plurality of first packets and the plurality of first null packet values in a first buffer;
extracting a plurality of second packets and a plurality of second null packet values corresponding to a second channel, wherein the plurality of second packets respectively correspond to the plurality of second null packet values;
storing the plurality of second packets and the plurality of second null packet values in a second buffer; and
selecting, according to the plurality of first null packet values and the plurality of second null packet values, one of the plurality of first packets and the plurality of second packets as an output packet.

9. The packet output method according to claim 8, wherein the step of selecting, according to the plurality of first null packet values and the plurality of second null packet values, one of the plurality of first packets and the plurality of second packets as the output packet comprises:
determining which of a first null packet value corresponding the first channel and a second null packet value corresponding to the second channel is 0; and
selecting a first packet as the output packet, wherein the first null packet value corresponding to the first packet is 0.

10. The packet output method according to claim 9, wherein the step of selecting, according to the plurality of first null packet values and the plurality of second null packet values, one of the plurality of first packets and the plurality of second packets as the output packet further comprises:
subtracting the second null packet value by 1 to generate an updated null packet value, wherein the second null packet value corresponding to the second packet is not 0.

11. The packet output method according to claim 10, wherein the step of selecting, according to the plurality of first null packet values and the plurality of second null packet values, one of the plurality of first packets and the plurality of second packets as the output packet further comprises:
determining which of a next null packet and the updated null packet value is 0, wherein the next null packet value and the updated null packet value respectively correspond to different channels.

12. The packet output method according to claim 11, wherein the step of selecting, according to the plurality of first null packet values and the plurality of second null packet values, one of the plurality of first packets and the plurality of second packets as the output packet further comprises:
selecting a packet corresponding to the next null packet value as the output packet when the next null packet value is 0; and
subtracting the updated null packet value by 1 as the updated null packet value.

13. The packet output method according to claim 11, wherein the step of selecting, according to the plurality of first null packet values and the plurality of second null packet values, one of the plurality of first packets and the plurality of second packets as the output packet further comprises:
selecting a packet corresponding to the updated null packet value as the output packet when the updated null packet value is 0; and
subtracting the next null packet value by 1 as the updated null packet value.

14. The packet output method according to claim 11, further comprising:
storing the plurality of second packets and the plurality of second null packet values received from the second buffer in the first buffer; and
receiving the second packet and the second null packet value from the first buffer.
